(19) United States
(12) Patent Application Publication
(10) Pub. No.: US 2020/0093688 A1
(43) Pub. Date: Mar. 26, 2020

(54) WEARABLE MAGNETIC PRESSURE POINT DEVICE

(71) Applicant: Daniella Pantaleo, Whitchurch-Stouffville (CA)

(72) Inventor: Daniella Pantaleo, Whitchurch-Stouffville (CA)

(21) Appl. No.: 16/582,072

(22) Filed: Sep. 25, 2019

Related U.S. Application Data
(60) Provisional application No. 62/736,600, filed on Sep. 26, 2018.

(51) Int. Cl. A61H 39/04; A61H 39/02

(52) U.S. Cl. CPC A61H 39/04; A61H 39/02; A61H 2201/1638; H01F 7/00; A61H 2201/102; A61H 2201/169; A61H 2201/01

(57) ABSTRACT

The wearable magnetic pressure point device disclosed herein may comprise, at least, a main body assembly, a strap assembly, a pressure point assembly, and a fluid disc. Such a device contemplates the use of resilient, flexible, and magnetic materials and is suitable for wearing. The purpose of the device is to allow a user to apply acupressure as needed, especially to the PC6 and TW5 locations around the wrist. The device is intended to be completely adjustable for different user needs, and resilient so that the device is resistant to weakening and a user may continue to apply consistent pressure over time. In certain embodiments the user may even apply pressure to the PC6 and TW5 locations simultaneously.

### TECHNICAL FIELD OF THE INVENTION

The present invention relates in general to wearable devices, and, more specifically, to a wearable magnetic pressure point device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Acupressure is an alternative medicine technique similar in principle to acupuncture. It is based on the concept of life energy which flows through meridians in the body. In treatment, physical pressure is applied to acupuncture points with the aim of clearing blockages in these meridians. Pressure may be applied by hand, by elbow, or with various devices. Some medical studies have suggested that acupressure may be effective at helping manage nausea and vomiting, for helping lower back pain, tension headaches, and stomach ache, depending on the pressure point to which the pressure is applied.

One such pressure point is known as Nei Guan (PC6), and is commonly used to help relieve nausea, upset stomach, motion sickness, carpal tunnel syndrome, and headaches. PC6 is located three finger widths below the wrist on the inner forearm in between the two tendons. To find and use this acupressure point a user may turn their hand with the palm facing up and apply downward pressure between the two tendons at that location.

Another such pressure point is known as Wai Guan (TW5), and is commonly used to help relieve rheumatism, tendonitis, wrist pain, and shoulder pain. TW5 is located on the back of the forearm, three finger widths above the wrist crease between the two bones located there. A user may access this acupressure point by turning their hand with the palm facing down and applying downward pressure between the two bones.

A device for applying such pressure, such as an acupressure wrist band, may be used to specifically target the PC6 or TW5 pressure points and may comprise, for example, a flexible band incorporating a solid pressure-applying component. Such a band may be adjustable through any appropriate means, especially by being stretchable or by having an adjustable strap, and may have one or more fixed solid components for applying pressure at the pressure point. Such devices, though, with their fixed components, may only apply pressure on one side of the wrist at a time, and may not be easily repositioned to a different pressure point. Further, the materials of composition of such bands, generally fabrics, may wear or lose elasticity over time, thereby reducing the effective amount of pressure that can be applied to the pressure point. The stretchiness of such a band may also limit the amount of pressure that can be applied to a user, especially where the user has a smaller wrist size, and the materials of construction may cause irritation or reduction of blood circulation to a user where the band is too small or too tight for their physiology.

Thus, there is a need in the art for a wearable magnetic pressure point device that comprises a plurality of adjustable pressure applying components that is also made from a resilient material of construction. It is to these ends that the present invention has been developed.

### BRIEF SUMMARY OF THE INVENTION

To minimize the limitations in the prior art, and to minimize other limitations that will be apparent upon reading and understanding the present specification, the present invention describes a wearable magnetic pressure point device.

It is an objective of the present invention to provide a wearable magnetic pressure point device that may comprise a resilient material.

It is another objective of the present invention to provide a wearable magnetic pressure point device that may comprise a main body assembly.

It is another objective of the present invention to provide a wearable magnetic pressure point device that may comprise a strap assembly.

It is another objective of the present invention to provide a wearable magnetic pressure point device that may comprise a pressure point assembly.

It is another objective of the present invention to provide a wearable magnetic pressure point device that may comprise a plurality of magnets.

It is another objective of the present invention to provide a wearable magnetic pressure point device that may comprise a fluid disc.

It is another objective of the present invention to provide a wearable magnetic pressure point device that may comprise a plurality of means for adjustment.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an overall view of a wearable magnetic pressure point device, as contemplated by the present disclosure;

FIG. 2 illustrates an overall view of a wearable magnetic pressure point device with the main body opened, as contemplated by the present disclosure;

FIG. 3 illustrates an overall view of a wearable magnetic pressure point device with the main body opened and containing an exemplary fluid disc, as contemplated by the present disclosure;

FIG. 4 illustrates an underside view of a wearable magnetic pressure point device showing the relative position of an exemplary pressure hemisphere, as contemplated by the present disclosure;

FIG. 5 illustrates an underside view of a wearable magnetic pressure point device showing an exemplary pressure hemisphere installed on the main body, as contemplated by the present disclosure;

FIG. 6 illustrates an exemplary hemisphere sled and pressure point device of a wearable magnetic pressure point device, as contemplated by the present disclosure;

FIG. 7 illustrates an overall view of a wearable magnetic pressure point device having an exemplary hemisphere sled installed, as contemplated by the present disclosure; and

FIG. 8 illustrates various orientations of a wearable magnetic pressure point device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to wearable devices, and, more specifically, to a wearable magnetic pressure point device. As contemplated by the present disclosure, the device comprises, at least, a main body assembly 100, a strap assembly 200, a pressure point assembly 300, and a fluid disc 400.

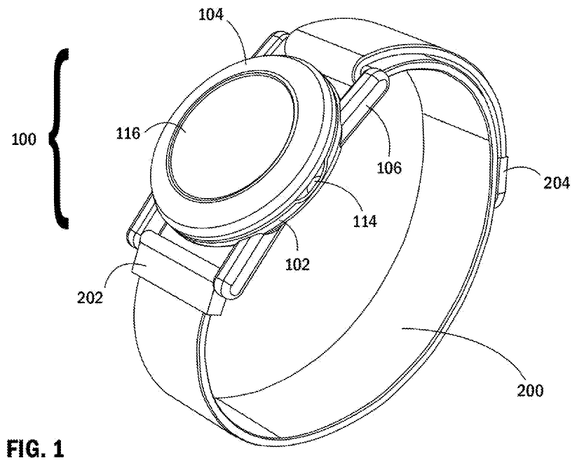

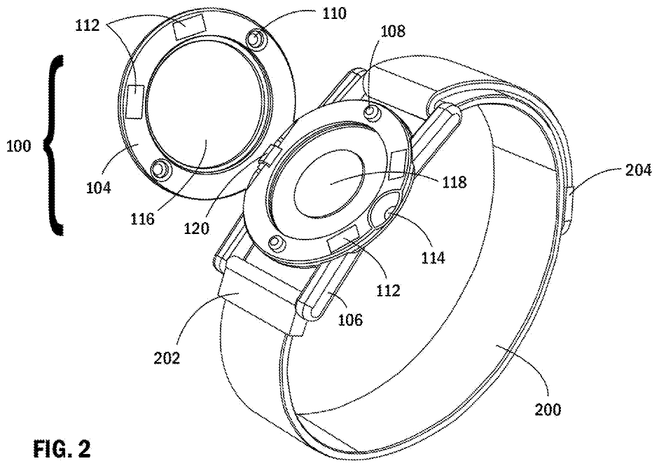

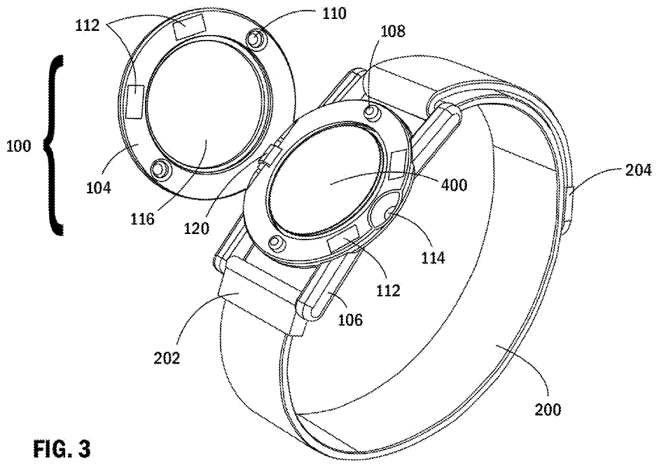

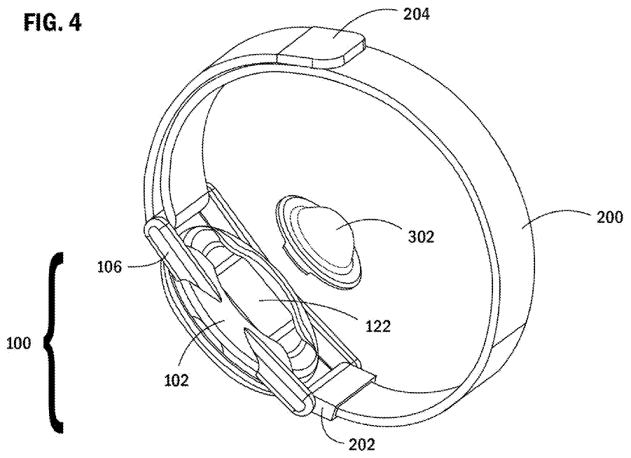

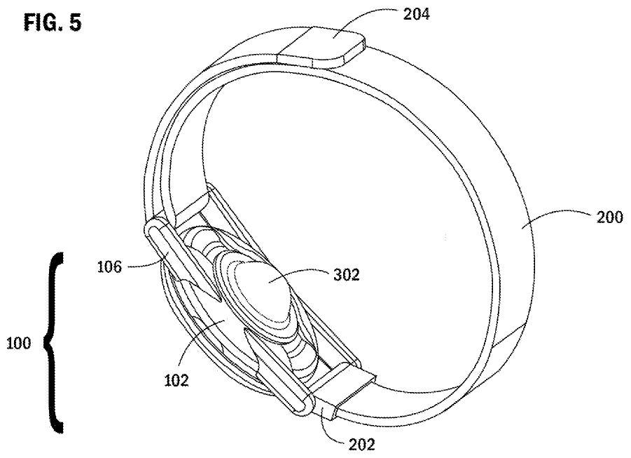

The illustrations of FIGS. 1 through 5 illustrate a wearable magnetic pressure point device as contemplated by the present disclosure. The main body assembly 100 further comprises a body base 102, a body lid 104, a plurality of body arms 106, a plurality of closure posts 108, a plurality of post receivers 110, a plurality of closure magnets 112, a notch 114, a decorative face 116, a base magnet 118, a hinge 120, and a hemisphere receiver 122.

The body base 102 may generally comprise any appropriate geometric shape having an upper surface, a lower surface, and a thickness, and being sized appropriately to wear on a user's wrist. The upper surface of the body base 102 may comprise a depressed central area and a relatively higher area forming a lip around the perimeter of the body base 102. The center of the depressed central area may comprise a further depressed core or a central cutout in which may be installed a base magnet 118. The lip around the perimeter of the body base 102 may comprise a plurality of closure posts 108, a plurality of closure magnets 112, a hinge 120, and a notch 114. The hinge 120 may be located opposite to the notch 114, and the notch 114 may be appropriately sized to receive a user's finger.

The body lid 104 may generally comprise any appropriate geometric shape having a perimeter identical to the body base 102, and having an upper surface, a lower surface, and a thickness. The lower surface of the body lid 104 may comprise a depressed central cutout identical in perimeter to the depressed central area of the body base 102, and a lip around the perimeter of the body lid 104 identical in size and shape to the lip of the body base 102. The central cutout of the body lid 104 may receive a plurality of decorative faces 116, which may be permanently or removably attached to the body lid 104. The lip around the perimeter of the body lid 104 may comprise a plurality of post receivers 110, a plurality of closure magnets 112, a hinge 120, and a notch 114. The hinge 120 may be located opposite to the notch 114 of the body lid 104 or, where a notch is not placed on the body lid 104, may be located opposite to the notch 114 of the body base 102. The hinge 120 may connect the body lid 104 with the body base 102, and a user may engage the notch 114 to apply opening force on the body lid 104 causing it swing on the hinge 120 axis from a closed position to an open position.

The plurality of closure posts 108 and plurality of post receivers 110 may be positioned anywhere around the perimeter of the body base 102 and body lid 104, respectively, and are positioned such that when the lower surface of the body lid 104 abuts the upper surface of the body base 102, the plurality of closure posts 108 are inserted into the plurality of post receivers 110. The plurality of closure magnets 112 on the body base 102 and body lid 104 are similarly positioned such that they magnetically attract one another and act as a closing force on the body lid 104.

The body base 102 may further comprise a plurality of body arms 106, which may be arranged in pairs having a cross bar connecting their free ends. A first pair of body arms 106 may be located substantially opposite to a second pair of body arms 106 such that a centerline may run through the first pair of body arms 106, through the body base 104, and then through the second pair of body arms 106. The lower surface of the body base 102 may further comprise a recessed area 122, which may be suitably shaped to receive a pressure hemisphere 302 and to permit the pressure hemisphere 302 to magnetically bind with the base magnet 118.

The various components of the main body assembly 100 may be made of any appropriate materials, though preferably comprise a resilient material so as to be durable in order to withstand regular and continued use. By way of example, the various components of the main body assembly 100 may comprise a material of construction of copper, aluminum, steel, brass, silver, gold, carbon fiber, fiberglass, or any combination thereof. The plurality of magnets used in the main body assembly 100 may comprise any appropriate magnetic material.

The strap assembly 200 further comprises a strap hinge 202, which may be attached to a first end of the strap assembly 200, and a strap magnet 204, which may be attached to a second end of the strap assembly 200. The strap hinge 202 may permanently or reversibly engage the cross bar of the first pair of body arms 106 such that the strap assembly 200 is articulably attached to the main body assembly 100. The strap magnet 204 may be inserted into the opening between the cross bar of the second pair of body arms 106 and the main body assembly 100 and then wrapped around the cross bar to magnetically and removably attach at any point on the strap assembly 200. The removable attachment of the strap magnet 204 to the strap assembly 200 may cause the formation of a loop whose inner area may be adjusted as desired, and into which may be placed a wrist of a user. The strap assembly 200, so as to be adjustable, may comprise a flexible material of construction, may comprise a solid material of construction in a chain mail structure, or may comprise any other appropriate means for maintaining adjustability.

The various components of the strap assembly 200 may be made of any appropriate materials, though preferably comprise a resilient flexible material so as to be durable in order to withstand regular and continued use. By way of example, the various components of the strap assembly 200 may comprise a material of construction of copper, aluminum, steel, brass, silver, gold, carbon fiber, fiberglass, or any combination thereof. The plurality of magnets used in the strap assembly 200 may comprise any appropriate magnetic material.

The fluid disc 400 may comprise any appropriate absorbent material suitable for supporting fluids. In an alternative embodiment the fluid disc 400 may comprise any appropriate container suitable for holding fluids. The fluid disc 400 is appropriately sized and shaped such that it fits within the cavity formed by the closure of the body base 102 and the body lid 104, and may be designed to permit fluids or aromas to emanate from within the cavity at a controlled rate.

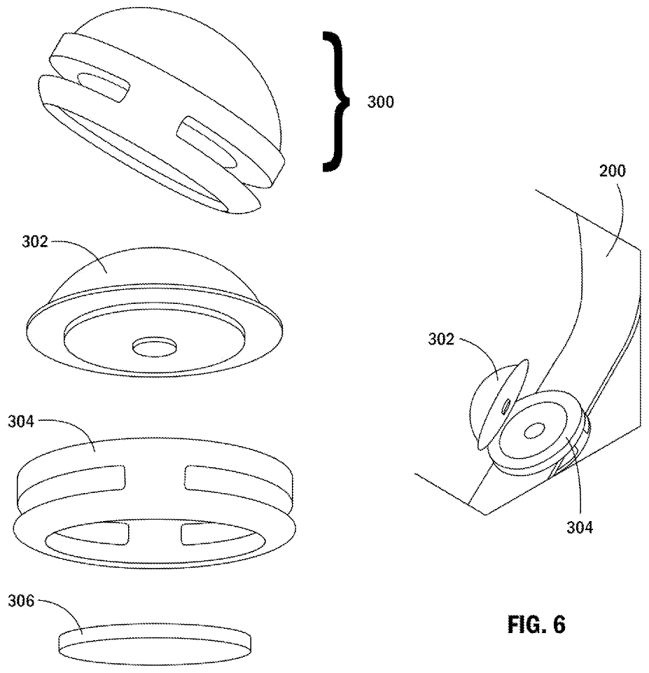

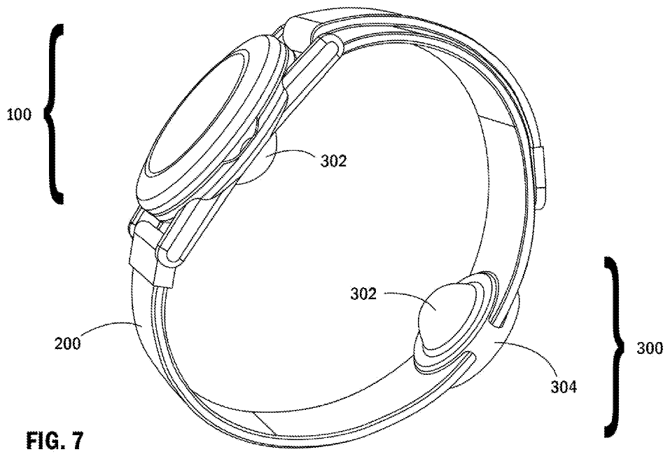

The illustrations of FIGS. 6 and 7 illustrate a pressure point assembly 300 of a wearable magnetic pressure point device. The pressure point assembly 300 further comprises a pressure hemisphere 302, a hemisphere sled 304, and a sled magnet 306. The hemisphere sled 304 may comprise an upper surface, a lower surface, a thickness, and a central core. The thickness of the hemisphere sled 304 may incorporate a plurality of slots appropriate sized to receive the strap magnet 204 and strap assembly 200 such that the hemisphere sled 304 may be installed around the strap assembly 200 and placed anywhere along its length, as desired. The lower surface of the hemisphere sled 304 may comprise an opening large enough to receive the sled magnet 306 into the central core of the hemisphere sled 304. The upper surface of the hemisphere sled 304 may comprise an opening large enough to receive the pressure hemisphere 302 and allow it to abut the sled magnet 306 such that the two components are magnetically removably attached.

The various components of the pressure point assembly 300 may be made of any appropriate materials, though preferably comprise a resilient material so as to be durable in order to withstand regular and continued use. By way of example, the various components of the pressure point assembly 300 may comprise a material of construction of copper, aluminum, steel, brass, silver, gold, carbon fiber, fiberglass, or any combination thereof. The plurality of magnets used in the pressure point assembly 300 may comprise any appropriate magnetic material.

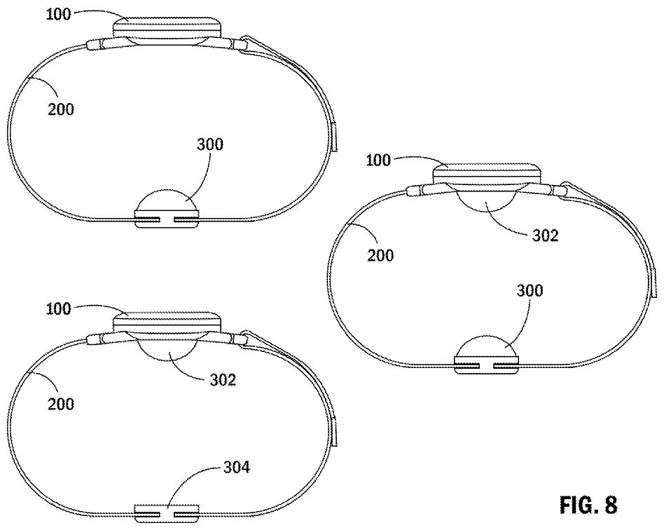

The illustration of FIG. 8 illustrates various orientations of a wearable magnetic pressure point device. The user may place the pressure hemisphere 302, as desired, in either the PC6 or TW5 position, or may place a plurality of pressure hemispheres 302 at both positions so as to affect both locations simultaneously.

In one embodiment wearable magnetic pressure point device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A wearable magnetic pressure point device, comprising:
a main body assembly;
a strap assembly; and
a fluid disc;
wherein said main body assembly further comprises a body base, a body lid, a plurality of body arms, a notch, and a hinge;
wherein said strap assembly further comprises a first end having a strap hinge and second end having a strap magnet;
wherein said body base further comprises an upper surface, a lower surface, and a thickness;
wherein said upper surface of said body base further comprises a depressed central area and a perimeter lip;
wherein said depressed central area of said upper surface of said body base further comprises a depressed core;
wherein said body lid further comprises an upper surface, a lower surface, and a thickness;
wherein said lower surface of said body lid further comprises a depressed central area and a perimeter lip;
wherein said hinge connects a first side of said perimeter lip of said body base to a first side of said perimeter lip of said body lid;
wherein said perimeter lip of said body base further comprises a second side having said notch opposite said first side of said perimeter lip of said body base;
wherein a proximal end of a first pair of said plurality of body arms are attached to a first end of said body base and a distal end of said first pair of said plurality of body arms comprises a first cross bar;
wherein a proximal end of a second pair of said plurality of body arms are attached to a second end of said body base opposite to said first end of said body base and a distal end of said second pair of said plurality of body arms comprises a second cross bar;
wherein said strap hinge of said strap assembly is attached to said first cross bar of said first pair of said plurality of body arms; and
wherein said fluid disc is installed into said depressed central area of said body base.

2. The invention of claim 1, further comprising:
a plurality of closure posts; and
a plurality of post receivers;
wherein said plurality of closure posts are attached to said perimeter lip of said body base;
wherein said plurality of post receivers are attached within said perimeter lip of said body lid; and
wherein said plurality of closure posts insert into said plurality of post receivers when said perimeter lip of said body base abuts said perimeter lip of said body lid.

3. The invention of claim 2, further comprising:
a plurality of closure magnets;
wherein a first set of said plurality of closure magnets are attached to said perimeter lip of said body base;
wherein a second set of said plurality of closure magnets are attached to said perimeter lip of said body lid; and
wherein said first set of said plurality of closure magnets magnetically attach to said second set of said plurality of closure magnets when said perimeter lip of said body base abuts said perimeter lip of said body lid.

4. The invention of claim 3, further comprising:
a base magnet;
a hemisphere receiver; and
a plurality of pressure hemispheres;
wherein said base magnet is installed into said depressed core of said body base;
wherein said hemisphere receiver comprises said lower surface of said body base; and
wherein a first of said plurality of pressure hemispheres is installed into said hemisphere receiver and magnetically attached to said base magnet.

5. The invention of claim 4, further comprising:
a pressure point assembly;
wherein said pressure point assembly further comprises a hemisphere sled, a sled magnet, and a second of said plurality of pressure hemispheres;
wherein said hemisphere sled further comprises a plurality of slots;
wherein said strap magnet of said strap assembly passes through said plurality of slots of said hemisphere sled so that said hemisphere sled slides along said strap assembly;
wherein said sled magnet is installed into said hemisphere sled; and
wherein said second of said plurality of pressure hemispheres is installed onto said hemisphere sled and magnetically attached to said sled magnet.

6. The invention of claim 5,
wherein said strap magnet passes through an opening formed by a combination of said second pair of said plurality of body arms and said body base, around said second cross bar, and is then attached to said strap assembly to form an adjustable loop.

7. The invention of claim 6,
wherein said strap assembly comprises a magnetic material of construction.

8. The invention of claim 7,
wherein said upper surface of said body lid further comprises a decorative face.

9. The invention of claim 8,
wherein said decorative face is removably attached to said body lid.

10. The invention of claim 9,
wherein said fluid disc emits an aroma.

11. The invention of claim 10,
wherein said fluid disc comprises an absorbent material.

12. The invention of claim 10,
wherein said fluid disc comprises a fluid container.
